(19) United States
(12) Patent Application Publication
(10) Pub. No.: US 2016/0271821 A1
(43) Pub. Date: Sep. 22, 2016

(54) VEGETABLE PROCESSOR

(71) Applicant: Zhui Chen, Fenton, MO (US)

(72) Inventor: Zhui Chen, Fenton, MO (US)

(21) Appl. No.: 14/663,718

(22) Filed: Mar. 20, 2015

(51) Int. Cl. B26D 3/28; B26D 1/03

(52) U.S. Cl. CPC B26D 3/283; B26D 1/03; B26D 2003/286

(57) ABSTRACT

A vegetable processor having a drum-like container with an inner cylindrical cavity shaped and sized to house a plurality of vegetables. The cavity has an inlet shaped and sized to allow vegetables to pass into the cavity there through, and an outlet positioned at least in part on the side of the container and shaped and sized to allow portions of said plurality of vegetables placed in the cavity to extend out of the cavity through the outlet. A pair of blade, positioned transverse to one another are attached to the side of the drum at the outlet. Vegetables in the drum are forced against the blades and out of the inner cavity by a set of paddles that rotate within the cavity, such that the blades substantially simultaneously cut the vegetables being processed in more than one direction.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention relates generally to an apparatus for the processing of foods, and more particularly to a novel powered vegetable cutting system that simultaneously utilizes a plurality of blades to efficiently and rapidly cut and slice vegetables into a desired size and shape with minimal effort.

In the commercial food processing and restaurant industries, it is often desirable or necessary to cut, slice or chop, i.e., process, vegetables into shapes and sizes for particular applications or packaging. For example, frozen mixed vegetables are often packaged as one-half to three-quarter inch cubes, a preferential size for consumption. Similarly, restaurants as well as vegetable producers will often process potatoes into a uniform size for purposes of, for example, preparing hash browns, mashing or use in soups. Further, in the restaurant industry it is often desirable to utilize freshly processed vegetables for daily food preparations. However, such relatively small-scale processing of fresh vegetables into desired shapes and sizes can be very time consuming.

Traditionally, small-scale processing of vegetables has been and continues to be performed by hand. One common method of automation to speed up this process is the use of a rotary drum that houses the vegetables. Centrifugal force or paddles in the drum force the vegetables against a fixed blade that slices portions off of the vegetables to fall outside the drum. Additional vegetables can be added as the volume of vegetables in the drum decreases. However, such rotary food process systems lack the ability to cut or slice the vegetables in more than one direction without multiple passes against the processor blade, such as when it is desired to process the vegetables into cubes or other such shapes.

It would therefore be desirable to have a rotary food processor for vegetables that could cut, chop and/or slice vegetables in more than one direction substantially simultaneously.

As will become evident in this disclosure, the present invention provides such benefits over the existing art.

### BRIEF DESCRIPTION OF THE DRAWINGS

The illustrative embodiments of the present invention are shown in the following drawings which form a part of the specification:

FIG. 1 is a perspective view of a representative embodiment of a vegetable processor of the present invention with a detachable vegetable rotary drum;

FIG. 2 is a perspective view of the attachment sleeve of the drive unit of the vegetable processor of FIG. 1 with the rotary drum removed;

FIG. 3 is a perspective view of the vegetable rotary drum of the vegetable processor of FIG. 1, separated from the drive unit with the blade cover open to expose the blades;

FIG. 4 is a plan view from the blade side of the vegetable rotary drum of the vegetable processor of FIG. 1, separated from the drive unit with the blade cover removed;

FIG. 5 is a plan view from the side opposite the blades of the vegetable rotary drum of the vegetable processor of FIG. 1, separated from the drive unit with the blade cover removed;

FIG. 6 is a top view of the vegetable rotary drum of the vegetable processor of FIG. 1, separated from the drive unit with the blade cover removed;

FIG. 7 is a bottom view of the vegetable rotary drum of the vegetable processor of FIG. 1, separated from the drive unit with the blade cover removed;

FIG. 8 is a plan view from the attachment side of the vegetable rotary drum of the vegetable processor of FIG. 1, separated from the drive unit with the blade cover removed;

FIG. 9 is a cross-sectional view facing the attachment side of the vegetable rotary drum of the vegetable processor of FIG. 1, separated from the drive unit with the blade cover removed;

FIG. 10 is a perspective view of the vegetable rotary drum of the vegetable processor of FIG. 1, separated from the drive unit with the blade cover and food chute removed; and

FIG. 11 is a perspective view of the detachable cross-cut blade for the vegetable rotary drum of the vegetable processor of FIG. 1.

Corresponding reference characters indicate corresponding parts throughout the several views of the drawings.

### DETAILED DESCRIPTION

While the invention will be described and disclosed here in connection with certain preferred embodiments, the description is not intended to limit the invention to the specific embodiments shown and described here, but rather the invention is intended to cover all alternative embodiments and modifications that fall within the spirit and scope of the invention as defined by the claims included herein as well as any equivalents of the disclosed and claimed invention.

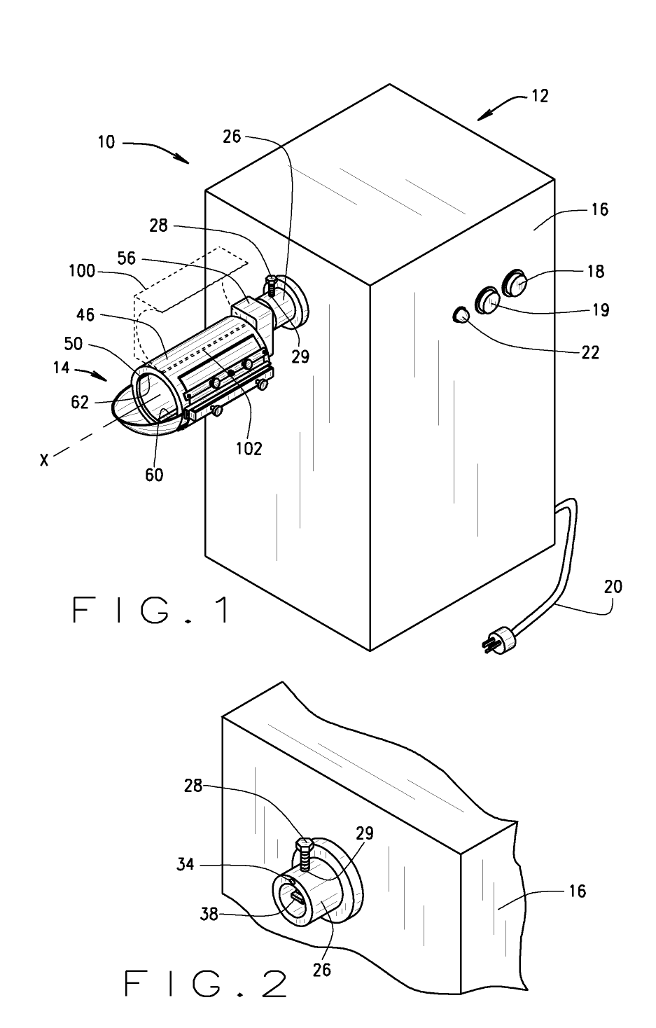

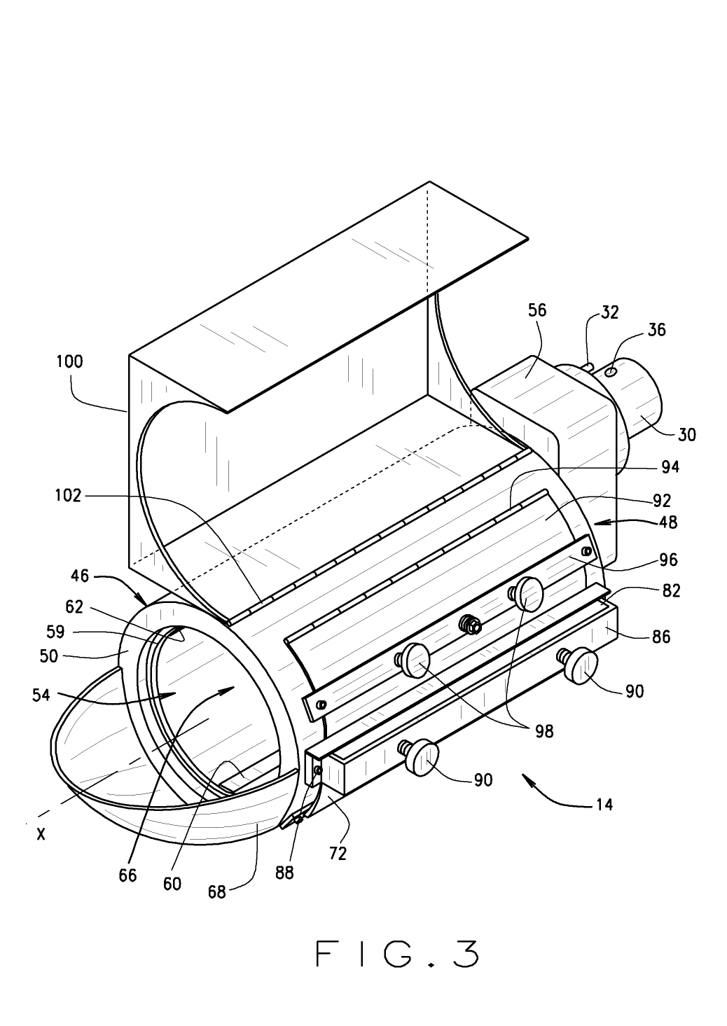

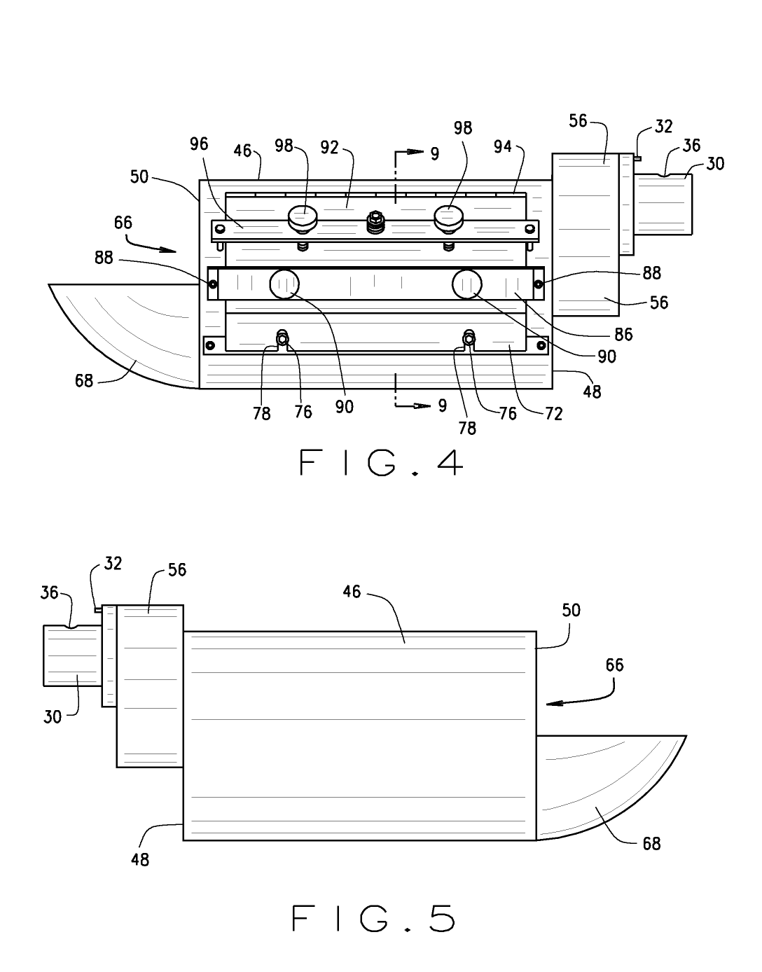

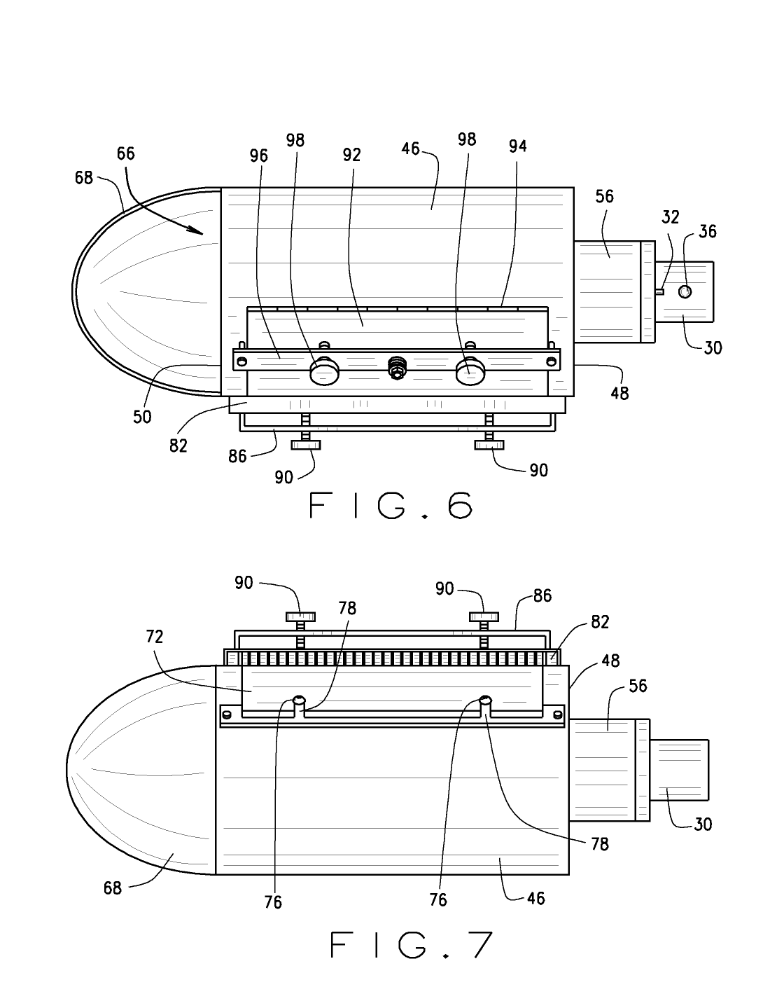

In referring to the drawings, a first embodiment of the novel vegetable processor 10 of the present invention is shown generally in FIGS. 1-11, where the present invention is depicted by way of example. As can be seen, the vegetable processor 10 comprises a drive unit 12 and a drum unit 14. The drive unit 12 comprises a body 16 that houses an electric motor (not shown) that is turned on or off by power switches 18 and 19. A power cord 20 connects the motor in the drive unit 12 to an electrical outlet. A display light 22 indicates when the electric motor in the drive unit 12 is turned on. A hollow cylindrical metal sleeve 26 positioned on a side of the drive unit 12 releasably attaches the drum unit 14 to the drive unit 12 (FIGS. 1 and 2).

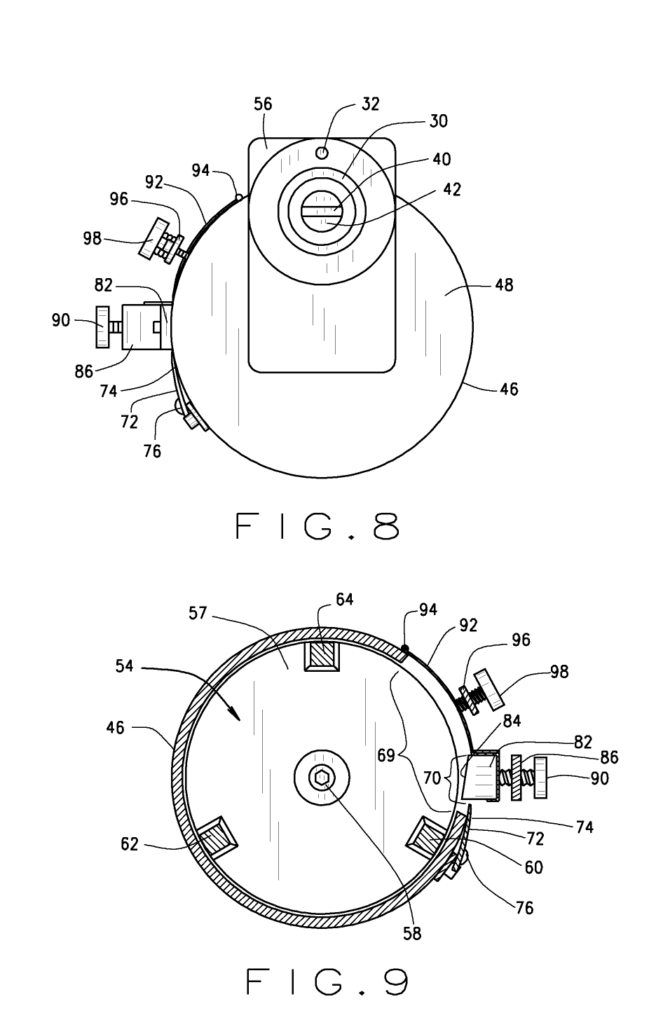

More particularly, in FIG. 3-8, it can be seen that a hollow cylindrical flanged neck 30 extends from the drum unit 14, and in FIG. 1 it can be seen that the flanged neck 30 fits snugly within the sleeve 26. An alignment pin 32 extends perpendicularly from the flange of the neck 30, and is received in an alignment bore 34 in the end of the sleeve 26 when the drive unit 12 and drum unit 14 are properly aligned together for attachment. A set screw 28 positioned in a threaded bore 29 on the side of sleeve 26 tightens on the flanged neck 30 into a depression 36 shaped to receive the tip of set screw 28. A rectangular tongue 38 positioned in the sleeve 26 extends from the shaft of the electric motor (not shown) housed in the drive unit 12. The tongue 38 mates with a slot 40 in a shaft 42 (see FIG. 8) positioned in the flanged neck 30 of the drum unit 14 when the drum unit 14 and drive unit 12 are properly aligned and attached to one another as shown in FIG. 1.

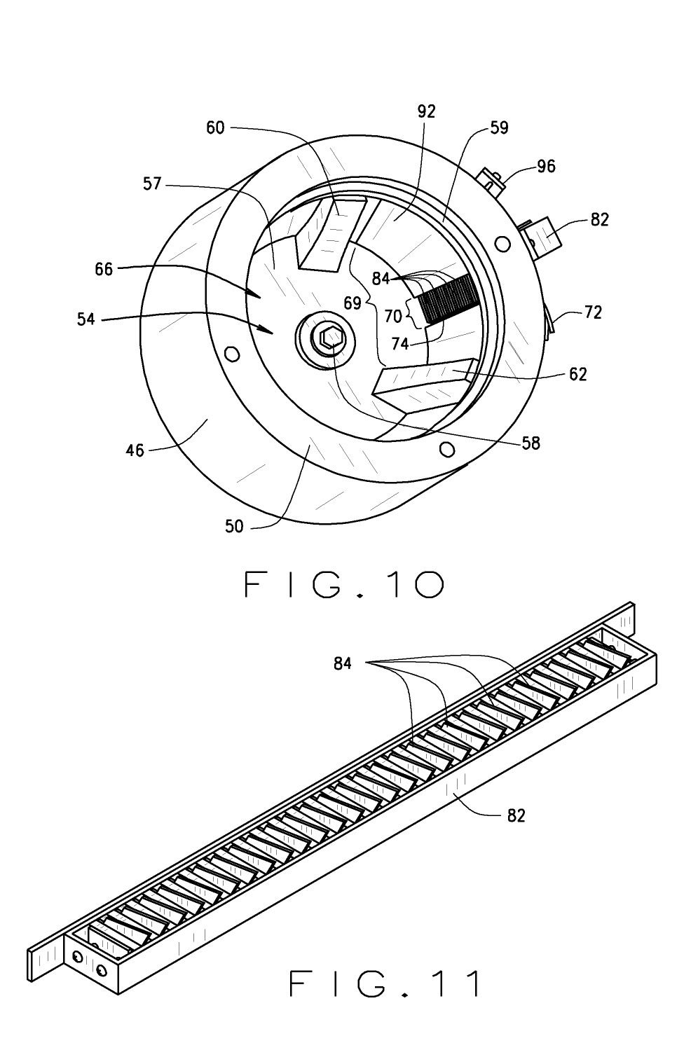

Referring again to FIGS. 3-8, and 9-10, it can be seen that the drum unit 14 has a hollow cylindrical stainless steel body 46 with a generally flat and circular stainless steel first end 48, a generally flat and circular stainless steel second end 50 parallel to the first end 48, and a cylindrical stainless steel sidewall 52 there between. The ends 48, 50 and the sidewall 52 define a metal drum with a cylindrical cavity 54 therein. The shaft 42 extends into a gearbox 56 that is mounted to the outside of the first end 48 of the drum unit 14. Gears in the gearbox (not shown) operatively connect the shaft 42 with a circular stainless steel plate 57 positioned in the cavity 54 in proximity to and parallel to the inner side of the first end 48. A bolt 58 (FIGS. 9-10) secures the plate 57 to the gears in the gearbox 56. The plate 57 extends in close proximity to, but does not touch, the first end 48 or the sidewall 52. In addition, a generally flat stainless steel ring 59 is positioned at the opposite end of the cavity 54 parallel to the plate 57. The ring 59 likewise is positioned close to, but does not touch, the second end 50 or the sidewall 52. The plate 57 and ring 59 have the same outer diameter.

A set of three elongated and generally trapezoidal paddles 60, 62 and 64 (FIGS. 9-10) extend between and rigidly attach the plate 57 to the ring 59. The paddles taper slightly as they extend from the plate 57 to the ring 59. Each of the paddles 60, 62 and 64 is positioned at the outer perimeter of the plate 57 and the ring 59. The plate 57, ring 59 and paddles 60, 62 and 64 collectively form an open cylindrical basket 65 within the cavity 54 of the drum unit 14. The basket 65 rotates about a central axis X that extends through the center length of the cylindrical cavity 54.

The second end 50 has a circular inlet 66 to access the cavity 54. A gravity-feed scoop-shaped trough or chute 68 is attached to and extends away from the face of the second end 50. As can be appreciated the chute 68 funnels vegetables to be processed through the inlet 66 and into the cavity 54 during operation.

A rectangular opening 69 (see FIGS. 9, 10) is positioned on the cylindrical body cylindrical body 46. The opening 69 extends lengthwise from a point in proximity to the first end 48 perpendicularly to a point in proximity to the second end 50, and has a width approximately one fourth to one fifth the circumference of the cylindrical body 46. Along one side of the opening 69 a removable first blade 72 with a straight cutting edge 74 is adjustably attached to the outer surface of the cylindrical body 46 adjacent and extending into the opening 69 such that the cutting edge 74 extends a short distance into the opening 69 at an oblique angle along the length of the opening 69. Screws 76 tighten on slots 78 along the backside of the first blade 72 opposite the cutting edge 74 to releasably and adjustably secure the first blade 72 to the outer surface of the cylindrical body 46. The slots 78 allow the accurate placement and positioning of the cutting edge 74 relative to the opening 69 in the cylindrical body 46. In addition, a second blade 82 comprising a series of transverse cutting edges 84 is releasably attached to the outer surface of the cylindrical body 46 above the first blade 72 by a metal brace 86 with the cutting edges 84 facing into the opening 69 and resting at one end on top of the cutting edge 74 of the first blade 72. A pair of screws 88 releasably secure the brace 86 to the outer surface of the cylindrical body 46 and a pair of knob screws 90 releasably and adjustably secure the second blade 82 in place within the brace 86.

On the opposite side of the opening 69, an adjustable thickness regulator plate 92 is rotatably secured to the outer surface of the cylindrical body 46 by a hinge 94. The regulator plate 92 is curved to substantially match the curvature of the cylindrical body 46, and has a width equal to the length of the opening 69 such that the plate 92 can be rotated into the opening 69 about the hinge 94. The regulator plate 92 extends from the hinge 94 partway across the opening 69 to a point approximately one inch from the side of the opening opposite the hinge 94. The regulator plate 92 thereby forms a smaller rectangular opening 70 into the cylindrical body 46 that has the length of the opening 69 and a width defined by the cutting edge 74 of the first blade 72 on one side and the edge of the regulator plate 92 opposite the hinge 94 on the other side. A spring-loaded brace 96 biases the regulator plate 92 toward the opening 69. Two knob screws 98 threaded into the brace 96 accurately adjust the extent to which the regulator plate 92 is allowed to push away from the opening 69 during operation.

In order to shield the operator from exposure to the blades 72 and 82 during operation, a removable blade cover 100 is positioned over the opening 69 above the blades 72 and 82. A piano hinge 102 rotatably attaches the blade cover 100 to the drum unit 14, such that the cover 100 can be rotated away from the opening 69 so as to allow ready access to the blades 72 and 82 as desired.

In operation, when vegetables are placed in the chute 68, gravity pulls those vegetables through the inlet 66 and into the basket 65 in the cavity 54. When an electric current is applied to the drive unit 12, the motor in the drive unit 12 rotates the flange 38, which in turn rotates the shaft 42, which in turn drives the gears in the gearbox 56 to rotate the basket 65 within the cavity 54. As the basket 65 rotates, the paddles 60, 62 and 64 stir the vegetables and, and in conjunction with centrifugal force, urge the vegetables against the cutting edges 74 and 84 of the first and second blades 72 and 82. As can be appreciated, although the vegetables first engage the cutting edges 84 of the second blade 82, and then engage the cutting edge 74 of the first blade 72 while rotating in the basket 65, the proximity of the blades in this arrangement result in a process in which the vegetables are cut or chopped in two differing directions at substantially the same time in a single pass.

While I have described in the detailed description several configurations that may be encompassed within the disclosed embodiments of this invention, numerous other alternative configurations, that would now be apparent to one of ordinary skill in the art, may be designed and constructed within the bounds of my invention as set forth in the claims. Moreover, the above-described novel mechanisms of the present invention, shown by way of example at 10 can be arranged in a number of other and related varieties of configurations without departing from or expanding beyond the scope of my invention as set forth in the claims.

For example, the processor 10 and its component drive and drum units 12 and 14 can be configured and constructed of varying materials, shapes and sizes without departing from the teachings of this disclosure. It is also to be understood that the processor 10 can be configured such that the drum unit 14 is detachable from the drive unit 12, or the drum unit 14 can be an integral component of the entire processor 10 such that the drum unit 14 does not detach from the drive unit 12.

By way of further example, the processor 10 is not limited to a specific number of paddles in the basket 65 of the drum unit 14 such as the paddles 60, 62 and 64. Rather, the drum unit 14 can house virtually any number of paddles, from as few as one paddle to many more than the three paddles 60-64, so long as the paddles are sized to fit within the drum unit 14 and facilitate, or at least do not interfere with, the operation of the processor 10 as explained in this disclosure. Similarly, the processor 10 is not limited to a specific number of components to secure the paddles in the drum unit 14. For example, the paddles 60-64 can be secured within the drum unit 14 with a single ring or plate, or with multiple combinations of plates, rings or other components such as cross-braces.

The processor 10 can also be alternately configured with a wide variety of common devices, mechanisms and components to enable the adjustment of each of the blades 72 and 82 relative to the opening 69. In addition, the inlet 66 can be of any variety of shapes and sizes, and can be positioned at virtually any position on the drum unit 14, so long as the inlet 66 does not hinder the operation of the processor 10 and enables the operator to insert the vegetables into the cavity 54 of the drum unit 14 for processing. Likewise, the inlet 70 can be of any variety of shapes and sizes, and can be positioned at virtually any position on the drum unit 14, so long as the opening 69 is configured and positioned relative to the blades 72 and 82 so as to facilitate the proper operation of the processor 10 as described herein.

As a further example, the blades 72 and 82 need not be removable, replaceable or adjustable—all as described herein. Rather, by way of example, either or both of the blades 72 or 82 can be non-adjustable and/or fixed in place on the drum unit 14. In addition, each of the blades 72 and 82 can be configured with as few as one cutting edge or numerous cutting edges, and such multiple cutting edges can be associated with or secured to each blade by a variety of means or configurations, including for example a single component with multiple sharpened edges, or numerous components with one or more sharpened edges on each components and pressed against each other or screwed, soldered or welded together.

In addition, the processor 10 can be operated with just the blade 72. This can be accomplished by simply detaching the blade 82 from the processor 10, or adjusting the position of the blade 82 such that the cutting edges 84 do not engage the vegetables being processed. Likewise, the processor 10 can be operated with just the blade 82. This can be accomplished by simply detaching the blade 72 from the processor 10, or adjusting the position of the blade 72 such that the cutting edge 74 does not engage the vegetables being processed. Also, the processor 10 is not limited a single set of matched blades positioned together on the drum unit 12, such as 72 and 82. Rather, the processor 10 can be configured with multiple sets of two or more blades positioned at different locations on the drum unit 14. Moreover, any one or more of such multiple sets of blades may be configured with two or more blades.

The processor 10 can be configured with any of a wide variety of readily understood components and mechanisms to attach the drum unit 14 to the drive unit 12, and a wide variety of drive motors and associated gearing in the gearbox 56 can be used to rotate the paddles 60-64 in drum unit 14 at a desirable or predetermined rate of speed. Further, the drive unit 12 and drum unit 14 can incorporate components, such as a variable governor, changeable gears or a variable speed motor, to enable the operator to control and adjust the rotational speed and direction of the paddles 60-64 in the drum unit 14 about the axis X.

Of course, the processor 10 does not specifically require the use of an electric motor or drive such as the drive unit 12. Rather, the drive unit 12 can comprise any of a variety of powered drive devices, such as a combustion engine, or a water or steam driven mill, to rotate the paddles 60-64 in drum unit 12. Alternately, the drive unit 12 can be configured to be powered by manual operation.

The processor is also not limited to the use of paddles, such as the paddles 60-64, to stir or move the vegetables into communication with the cutting blades, such as the blades 72 and 82. Rather, alternate devices can be used to stir or move the vegetables within the drum unit 14, including for example, push rods, gears, baffles and pressurized air or other fluids. In addition, the processor 10 can be configured such that the drum unit 14, and consequently the blades 72 and 82, rotate about the axis X, while the vegetables are pressed against the blades by stationary baffles or paddles inside the drum unit 14.

Additional variations or modifications to the configuration of the novel mechanism of the present invention, shown by way of example at 10, may occur to those skilled in the art upon reviewing the subject matter of this invention. Such variations, if within the spirit of this disclosure, are intended to be encompassed within the scope of this invention. The description of the embodiments as set forth herein, and as shown in the drawings, is provided for illustrative purposes only and, unless otherwise expressly set forth, is not intended to limit the scope of the claims, which set forth the metes and bounds of my invention. Accordingly, all matter contained in the above description or shown in the accompanying drawings should be interpreted as illustrative and not in a limiting sense.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

1. A vegetable processor comprising:
a. a container having an inner cavity shaped and sized to house a plurality of vegetables therein, the cavity having a first end and a second end opposite the first with a substantially rigid generally cylindrical sidewall positioned between said first and second ends, the container further having an inlet and an outlet, the inlet shaped and sized to allow vegetables to pass into the cavity there through, the outlet positioned at least in part through the sidewall and shaped and sized to allow portions of said plurality of vegetables placed in the cavity to extend out of the cavity through the outlet;
b. a first paddle positioned in the cavity, the first paddle moving between a first position and a second position to propel the plurality of vegetables across the outlet in a first direction;
c. a first blade having a first cutting edge, the first blade attached to the container in proximity to the outlet, the first cutting edge oriented at an oblique angle to the first direction to slice off portions of the plurality of vegetables extending through the outlet when the paddle propels said plurality of vegetables across the outlet;
d. a second blade attached to the container in proximity to the outlet, the second blade having a plurality of cutting edges oriented at least partially transverse to the first blade cutting edge to cross-slice the portions of the plurality of vegetables sliced off by the first blade; and
e. a drive adapted to urge the paddle to move between said first and second positions.

2. The vegetable processor of claim 1, wherein the drive comprises an electric motor, the electric motor providing propulsion to urge the first paddle to move between said first and second positions.

3. The vegetable processor of claim 1, wherein the container removably attaches to the drive.

4. The vegetable processor of claim 1, wherein the first paddle pivots about an axis X between the first and second positions.

5. The vegetable processor of claim 4, wherein the first paddle rotates about the axis X along an arc, said arc comprising the first and second positions.

6. The vegetable processor of claim 4, wherein the axis X intersects one of said first and second ends of the container.

7. The vegetable processor of claim 6, wherein the sidewall comprises a cylindrical arc radially parallel to the axis X.

8. The vegetable processor of claim 7, wherein the first paddle comprises a substantially linear edge oriented substantially parallel to the axis X at a radius R from the axis X, and the first and second blade cutting edges are positioned at a distance slightly greater than the radius R.

9. The vegetable processor of claim 1, further comprising an adjustment mechanism operatively associated with the first blade, said adjustment mechanism controllably adjusting position of the first blade relative to the outlet.

10. The vegetable processor of claim 1, wherein the first blade cutting edge comprises a shape, said shape being one of substantially linear, curved, or contoured.

11. The vegetable processor of claim 1, further comprising a plurality of paddles positioned in the cavity, each paddle of said plurality of paddles pushing the plurality of vegetables across the outlet in the first direction.

12. The vegetable processor of claim 1, further comprising a second paddle positioned in the cavity, the second paddle moving between a third position and a fourth position to push the plurality of vegetables across the outlet in a second direction different from said first direction.

13. The vegetable processor of claim 1, further comprising an adjustment mechanism operatively associated with the second blade, said adjustment mechanism controllably adjusting one of the angle of the second blade relative to the first direction, the separation of the second blade from the container, the separation of the second blade from the first blade, the angle of the second blade relative to the first blade, and the position of the first blade cutting edge relative to the outlet.

14. The vegetable processor of claim 1, wherein the plurality of cutting edges of the second blade are positioned relative to the first blade cutting edge to cross-slice vegetables extending from the cavity through the outlet at substantially the same time as the first blade cutting edge slices said vegetables.

15. The vegetable processor of claim 1, wherein the first blade removably attaches to the container.

16. The vegetable processor of claim 1, wherein the second blade removably attaches to the container.

17. A modular vegetable processor comprising:
a. a drum module comprising:
i. a container having an inner cavity shaped and sized to house a plurality of vegetables therein, the cavity having a first end and a second end opposite the first with a substantially rigid sidewall positioned between said first and second ends, the container further having an inlet and an outlet, the inlet shaped and sized to allow vegetables to pass into the cavity there through, the outlet positioned at least in part on the sidewall and shaped and sized to allow portions of said plurality of vegetables placed in the cavity to extend out of the cavity through the outlet;
ii. a first paddle positioned in the cavity, the first paddle moving between a first position and a second position to push the plurality of vegetables across the outlet in a first direction;
iii. a plurality of blades positioned in proximity to the outlet, each blade of said plurality of blades having a cutting edge oriented at an oblique angle to the first direction, each blade slicing through portions of the plurality of vegetables extending through the outlet when the paddle pushes said plurality of vegetables across the outlet; and
iv. a first attachment mechanism; and
b. a drive module comprising:
i. a mechanical drive; and
ii. a second attachment mechanism configured to releasably engage the first attachment mechanism, the drive urging the first paddle to move between said first and second positions when the second attachment mechanism is engaged with the first attachment mechanism and the drive is activated.

18. A vegetable processor comprising:
a. a drum having a cylindrical inner cavity shaped and sized to house a plurality of vegetables therein, the cavity having a first end and a second end opposite the first with a substantially rigid generally cylindrical sidewall positioned between said first and second ends and having a central axis X, the container further having an inlet and an outlet, the inlet shaped and sized to allow vegetables to pass into the cavity there through, the outlet positioned at least in part on the sidewall and shaped and sized to allow portions of said plurality of vegetables placed in the cavity to extend out of the cavity through the outlet;
b. a plurality of paddles positioned in the cavity, each of said plurality of paddles extending between a first circular plate and a second circular plate to form a cylindrical partially open basket within the cavity, the basket rotating about the axis X such that the plurality of paddles propel the plurality of vegetables across the outlet in a first direction;
c. a first blade having a first cutting edge, the first blade attached to the container in proximity to the outlet, the first cutting edge oriented at an oblique angle to the first direction to slice off portions of the plurality of vegetables extending through the outlet when the plurality of paddles propel said plurality of vegetables across the outlet;
d. a second blade attached to the container in proximity to the outlet, the second blade having a plurality of cutting edges oriented at least partially transverse to the first blade cutting edge to cross-slice the portions of the plurality of vegetables sliced off by the first blade; and
e. a drive adapted to rotate the basket about the axis X.
